(19) United States
(12) Patent Application Publication
(10) Pub. No.: US 2015/0363953 A1
(43) Pub. Date: Dec. 17, 2015

(54) IMAGE SWITCHING METHOD AND DEVICE

(71) Applicant: Xiaomi Inc., Beijing (CN)

(72) Inventor: Shengli LIU, Beijing (CN)

(73) Assignee: Xiaomi Inc., Beijing (CN)

(21) Appl. No.: 14/586,023

(22) Filed: Dec. 30, 2014

Related U.S. Application Data
(63) Continuation of application No. PCT/CN2014/089287, filed on Oct. 23, 2014.

(30) Foreign Application Priority Data
Jun. 11, 2014 (CN) 201410257716.X

(51) Int. Cl. G06T 11/60; G06T 7/40

(52) U.S. Cl. CPC G06T 11/60; G06T 7/408; G06T 2207/10004; G06T 2207/20212

(57) ABSTRACT

An image switching method and the device thereof may include: overlapping a first resolution version of an ith image on a second resolution version of the ith image currently displayed, the resolution of the first resolution version being below that of the second resolution version, i≧1; and replacing the second resolution version of the ith image with the second resolution version of the (i+1)th image; hiding the first resolution version of the ith image according to predetermined animation effects and displaying the second resolution version of the (i+1)th image. Smooth switching of the second resolution versions of two adjacent images is realized by way of the animation effect generated by the first resolution version of the previous image, thus improving the switching and displaying effect.

### PRIORITY STATEMENT

This application is a Continuation application of International Application No. PCT/CN2014/089287, filed on Oct. 23, 2014, which is based upon and claims priority of Chinese Patent Application No. 201410257716.X, filed on Jun. 11, 2014, the entire contents of which are incorporated herein by reference.

### TECHNICAL FIELD

The present disclosure generally relates to the field of image processing, and more particularly, to an image switching method and device.

### BACKGROUND

4K resolution is an emerging standard for digital film and computer video with ultra-high resolution. Common 4K resolution includes 3840×2160 pixel and 4096×2160 pixel. “4K” takes its name from number of pixels in the horizontal direction.

With the development of 4K technology, more and more attention is paid to 4K TV, 4K image and 4K video. Wherein, 4K image refers to an image whose resolution is below 4K, also known as ultra-high definition image. 4K image is fine in display quality and bright in color, allowing users to clearly see every detail and close-up in frames.

### SUMMARY

According to an aspect of the present disclosure, an electronic device may comprise a processor-readable storage medium storing a set of instructions for displaying a group of images; and a processor in communication with the storage medium. When executing the set of instructions, the processor may be directed to overlap a first image with a first resolution over the first image with a second resolution that is currently displayed by the electronic device; replace the first image with the second resolution with a second image with the second resolution; hide the first image with the first resolution according to a predetermined animation effect; display the second image with the second resolution.

According to another aspect of the present disclosure, a method for displaying a group of images may comprise, by an electronic device, overlapping a first image with a first resolution over the first image with a second resolution that is currently displayed by an electronic device; replacing the first image with the second resolution with a second image with the second resolution; hiding the first image with the first resolution according to a predetermined animation effect; and displaying the second image with the second resolution.

According to yet another aspect of the present disclosure, a non-transitory processor-readable storage medium may comprise a set of instructions for displaying a group of images. When being executed by a processor, the set of instructions directs the processor to conduct operations of overlapping a first image with a first resolution over the first image with a second resolution that is currently displayed by an electronic device; replacing the first image with the second resolution with a second image with the second resolution; hiding the first image with the first resolution according to a predetermined animation effect; and displaying the second image with the second resolution.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flowchart showing an image switching method according to an example embodiment;

FIG. 2A is a flowchart showing an image switching method according to another example embodiment;

FIG. 2B is a schematic diagram showing image switching and displaying according to an example embodiment;

FIG. 3 is a block diagram of an image switching device according to an example embodiment;

FIG. 4 is a block diagram of an image switching device according to another example embodiment;

FIG. 5 is a block diagram of an example electronic device.

Example embodiments of the present disclosure are shown by the above drawings, and more detailed description will be made hereinafter. These drawings and text description are not for limiting the scope of conceiving the present disclosure in any way, but for illustrating the concept of the present disclosure for those skilled in the art by referring to specific embodiments.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims.

Firstly it should be explained that, in embodiments of the present disclosure, the electronic equipment involved may be a smart mobile phone, a tablet computer, an e-book reader, a MP3 (Moving Picture Experts Group Audio Layer III) player, a MP4 (Moving Picture Experts Group Audio Layer IV) player, a laptop computer, a desktop computer, a smart television and the like.

In addition, the first resolution version and the second resolution version of an image are pre-stored in the electronic equipment. Concerning both the foregoing versions of the same image, the resolution of the first resolution version is below that of the second resolution version, and both the first resolution version and the second resolution version have identical or similar image size, color saturation and brightness and other parameters.

Embodiments of the present disclosure are illustrated by taking the first resolution version as 2K resolution version and the second resolution version as 4K resolution version. In other possible implementations, the first resolution version may be a version with lower resolution, such as 720P resolution, 1080P resolution or 2K resolution; while the second resolution version may be a version with higher resolution, such as 4K resolution or 8K resolution. Therefore, concerning both the foregoing versions of the same image, it is acceptable as long as the resolution of the first resolution version is below that of the second resolution version, and the embodiment makes no specific restriction on actual resolutions of both the foregoing versions.

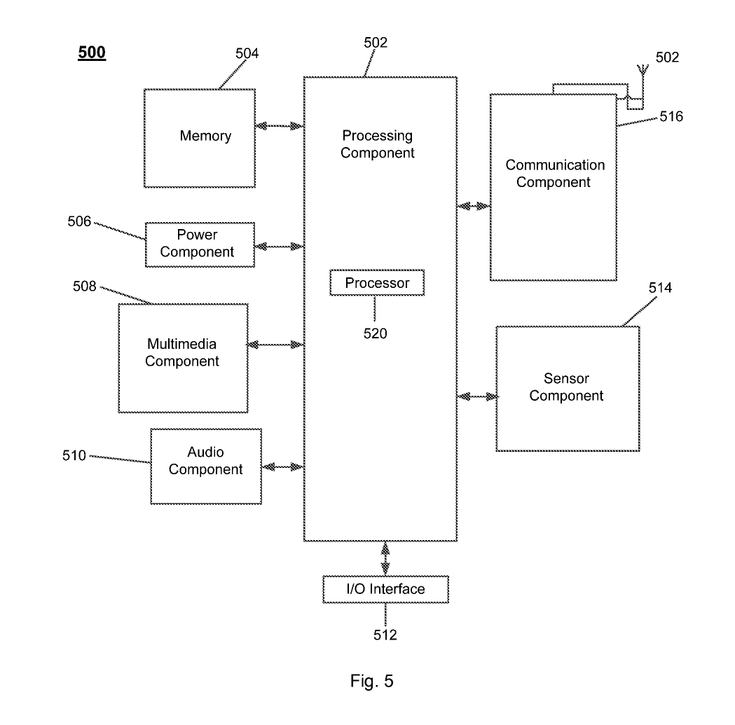

FIG. 5 is a block diagram of an image switching device 500 according to an example embodiment. For example, the device 500 may be a mobile telephone, a computer, a digital broadcasting terminal, a message transceiver device, a games console, a tablet device, a medical device, a fitness facility, a PDA (personal digital assistant) and the like.

The device 500 may include one or a plurality of components as below: a processor component 502, a memory 504, a power supply component 506, a multimedia component 508, an audio component 510, an input/output (I/O) interface 512, a sensor component 514 and a communication component 516.

The processor component 502 usually controls the overall operation of the device 500, for example, display, telephone call, data communication, and operation associated with camera operation and record operation. The processor component 502 may include one or a plurality of processors 520 for executing instructions so as to complete operations of above method in part or in whole. In addition, the processor component 502 may include one or a plurality of components for the convenience of interaction between the processor component 502 and other components. For example, the processor component 502 may include a multimedia module for the convenience of interaction between the multimedia component 508 and the processor component 502.

The memory 504 is configured to store data of different types so as to support the operation of the device 500. Examples of the data include any application program or approach directive for operation of the device 500, including contact data, phonebook data, message, picture and video, and/or sets of instructions that implementing methods introduced in the present disclosure etc. The memory 504 may be realized by volatile or non-volatile memory device of any type or combination thereof, for example, static random access memory (SRAM), electrically erasable programmable read-only memory (EEPROM), erasable programmable read only memory (EPROM), programmable read-only memory (PROM), read-only memory (ROM), magnetic memory, flash memory, magnetic disk or optical disk.

The power supply component 506 provides power for components of the device 500. The power supply component 506 may include a power management system, one or a plurality of power supplies, and other components associated with power generation, management and distribution of the device 500.

The multimedia component 508 includes a screen between the device 500 and a user and for providing an output interface. In some embodiments, the screen may include an LCD (Liquid Crystal Display) and a touch panel (TP). If the screen includes a touch panel, the screen may be realized as a touch screen for receiving input signal from users. The touch panel includes one or a plurality of touch sensors for sensing gestures on the touch panel, for example, touching and sliding, etc. The touch sensor not only may sensor trip boundary of touching or sliding, but also may detect the duration and pressure related to the touching or sliding operation. In some embodiments, the multimedia component 508 includes a front-facing camera and/or a rear-facing camera. When the device 500 is under an operation mode, for example, capture mode or video mode, the front-facing camera and/or the rear-facing camera may receive external multimedia data. Each front-facing camera and rear-facing camera may be a fixed optical lens system or have focal length and optical zoom capacity.

The audio component 510 is configured to output and/or input audio signal. For example, the audio component 510 includes a microphone (MIC). When the device 500 is under an operation mode such as call mode, record mode and speech recognition mode, the microphone is configured to receive external audio signal. The audio signal received may be further stored in the memory 504 or sent out by the communication component 516. In some embodiments, the audio component 510 also includes a loudspeaker for outputting audio signal.

The I/O interface 512 provides interface for the processor component 502 and peripheral interface components, the peripheral interface components may be a keyboard, a click wheel and buttons, etc. These buttons may include but not limited to: home button, volume button, start button and locking button.

The sensor component 514 includes one or a plurality of sensors for providing the device 500 with state evaluation from all aspects. For example, the sensor component 514 may detect the on/off state of the device 500, relative positioning of components, for example, the components are the displayer and keypads of the device 500. The sensor component 514 also may detect the position change of the device 500 or a component thereof, the presence or absence of users' touch on the device 500, the direction or acceleration/deceleration of the device 500, and temperature variation of the device 500. The sensor component 514 may also include a proximity detector, which is configured to detect the presence of nearby objects in case of no physical touch. The sensor component 514 may also include an optical sensor, for example, CMOS or CCD image sensor for imaging. In some embodiments, the sensor component 514 may also include an acceleration sensor, a gyro sensor, a magnetic sensor, a pressure sensor, or a temperature sensor.

The communication component 516 is configured for the convenience of wired communication or wired communication between the device 500 and other equipment. The device 500 is available for access to wireless network based on communication standards, for example, Wi-Fi, 2G or 3G, or combination thereof. In an example embodiment, the communication component 516 receives by means of a broadcast channel the broadcast signal or broadcast-related information from external broadcast management systems. In an example embodiment, the communication component 516 also includes a near field communication (NFC) module for promoting short-range communication. For example, the NFC module may be realized on the basis of Radio Frequency Identification (RFID) Technology, Infrared Data Association (IrDA) Technology, Ultra-wide Bandwidth (UWB) Technology, Bluetooth (BT) Technology and other technologies.

In example embodiments, the device 500 may be realized by one or a plurality of application specific integrated circuits (ASIC), digital signal processors (DSP), digital signal processing equipment (DSPD), programmable logic devices (PLD), field programmable gate arrays (FPGA), controllers, microcontrollers, microprocessors or other electronic components, configured to execute the image switching methods as disclosed in the present disclosure.

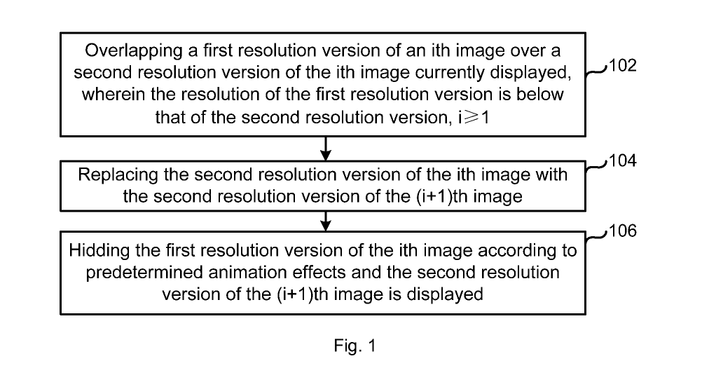

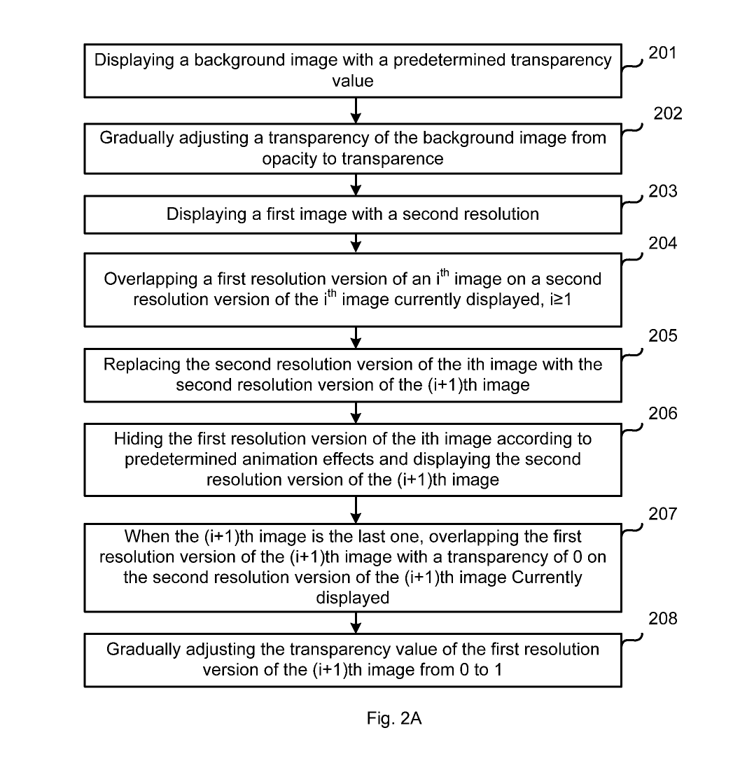

In example embodiments, a non-temporary computer-readable storage medium including instructions is also provided, for example, a memory 504 including instructions, above instructions may be executed by the processors 520 of the device 500 so as to achieve the image switching method as shown in FIG. 1 or FIG. 2A. For example, the non-temporary computer-readable storage medium may be ROM, random access memory (RAM), CD-ROM, magnetic tape, floppy disk and optical data storage device, etc.

A non-temporary computer-readable storage medium, wherein instructions in the storage medium are executed by processors of the device 500 so as to execute the image switching methods in the present disclosure.

Merely for illustration, only one processor will be described in the device 500 that execute operations and/or method operations in the following example embodiments. However, it should be note that the device 500 in the present disclosure may also include multiple processors, thus operations and/or method operations that are performed by one processor as described in the present disclosure may also be jointly or separately performed by the multiple processors. For example, if in the present disclosure a processor of a device 500 executes both operation A and operation B, it should be understood that operation A and operation B may also be performed by two different processors jointly or separately in device 500 (e.g., the first processor executes operation A and the second processor executes operation B, or the first and second processors jointly execute operations A and B).

FIG. 1 is a flowchart showing an image switching method according to an example embodiment. The method may be implemented by electronic equipment such as the device 500 in FIG. 5. The image switching method may include the following operations:

In Operation 102, the device 500 may overlap a first resolution version of an ith image (e.g., a first image) in a group of images over a second resolution version of the ith image currently displayed, wherein the resolution of the first resolution version is below that of the second resolution version, i≧1.

For example, the first resolution may be a 2K resolution; and the second resolution may be a 4K resolution. A 2K resolution image may be an image of 2048×1536 pixels, 2048×1556 pixels (full-aperture), 2048×1152 pixels (HDTV, 16:9 aspect ratio) or 2048×872 pixels (Cinemascope, 2.35:1 aspect ratio). A 4K resolution image may be an image of 4096×2160 pixels or 3840×2160 pixels.

In Operation 104, the device 500 may replace the second resolution version of the ith image with the second resolution version of the (i+1)th image.

In Operation 106, the device 500 may hide the first resolution version of the ith image according to predetermined animation effects and display the second resolution version of the (i+1)th image (e.g., a second image).

In conclusion, the image switching method provided by the embodiment solves a problem that smooth switching is unavailable among a plurality of 4K images by means of predetermined animation effects, thus leading to poor display effect. During switching and displaying 4K images, the device 500 may execute the image switching method to overlap a first resolution version of an ith image on a second resolution version of the ith image currently displayed on the device 500, replace the second resolution version of the ith image with a second resolution version of an (i+1)th image, and hide the first resolution version of the ith image according to the predetermined animation effects, and display the second resolution version of the (i+1)th image. In the process of switching the second resolution versions of two adjacent images, the device 500 may use the first resolution version of the previous image to serve as a linkage, smooth switching of the second resolution versions of both the adjacent images by the animation effect generated by the first resolution version of the previous image. Thus the method not only improves the effect during switching and displaying both images but also enhances user experience.

FIG. 2A is a flowchart showing an image switching method according to another example embodiment. The method may be implemented by electronic equipment such as the device 500 in FIG. 5. The image switching method may include the following operations:

In Operation 201, the device 500 may display a background image with a predetermined transparency.

Prior to switching and displaying the second resolution versions of a group of images, the device 500 may firstly display the background image with a predetermined transparency value. For example, the transparency value may be 1, which renders the background image opaque. The background image may be a preset image, and the background image may be an image of the first resolution. For example, the background image is a black image with a 2K resolution, i.e., the background image may have a resolution of 2048×1536 pixels, 2048×1556 pixels, 2048×1152 pixels, or 2048×872 pixels.

The device 500 may overlap the background image with the second resolution version of the first image. The first image is an image displayed first in a group of images to be displayed by the device 500. Each image in the group of images may include two versions of resolution: the first resolution of each image may be 2K resolution version and the second resolution of each image may be 4K resolution.

FIG. 2B is a schematic diagram showing a procedure of image switching and displaying of the group of images. As an example, the group of images in FIG. 2B includes three images: the first image, the second image, and the third image.

Prior to switching and displaying the three images, the device 500 may first overlap the background image 21 over the 4K resolution version 22 of the first image. At the moment the background image 21 may be opaque, i.e., the background image 21 may have a transparency value of 1.

In actual display effect, when two images are mutually overlapped and one image (a front side image) is displayed over another image (a back side image), the back side image is covered over entirely by the front side image in terms of dimensions. In FIG. 2B, the back side image is outlined in a dotted line so as to more clearly illustrate the overlap of images.

In Operation 202, the device 500 may gradually adjust the background image from opacity to transparence.

For example, the device 500 may gradually adjust the transparency value of the background image from 1 to 0, wherein an image is opaque when its transparency value is 1, and the image is completely transparent when its transparency value is 0. Accordingly, when the transparency of the background image is gradually adjusted from 1 to 0, the background image gradually changes from opacity to complete transparence, i.e., the background image fades out in a fade-out animation effect. In the meantime, as the background image gradually fad-out, the second resolution version of the first image overlapped under the background image fades in.

In Operation 203, the device 500 may display the first image with the second resolution.

The second resolution version of the first image is fully displayed when the transparency value of the background image turns into 0. In an automatically display mode, the device 500 may display the second resolution version of the first image for a preset display duration and automatically switch to display the next image (e.g., a second image) in the group of images. In a manual display mode, the device 500 may keep displaying the second resolution version of the first image until receiving an instruction (e.g., a trigger signal) from a user to display the next image.

As shown in FIG. 2B, the 4K resolution version 22 of the first image is fully displayed when the transparency of the background image 21 is gradually adjusted from 1 to 0. In the example in FIG. 2B, the device 500 only adjusts the transparency of the front side image (or upper image, such as the background image) to display the back side image (or under image, such as the first image) in a fade-in animation effect. It should be note that the present application intends to cover the broadest ways of switching and displaying an image after another. For example, the device 500 may fade out the front side image by way of other animation effects such as jalousie, checkerboard, fly-out, splitting and the like in order to switch from the front side image to the back side image, on which the embodiment makes no specific restriction.

Accordingly, through Operations 201-203, the device 500 may be able to switch from displaying the background image to displaying the first image under the second resolution version of the first image is switched out of the background image. The effect is achieved by placing the background image over the first image and gradually fading away the background image.

When the device 500 switches from displaying the first image to the second image in the group of images, or switches from displaying an ith image from an (i+1)th image, it may execute Operations 204-206.

In Operation 204, the device 500 may overlap a first resolution version of the ith image on a second resolution version of the ith image currently displayed, i≧1.

For the same image, the first resolution version may have an image resolution lower than that of the second resolution. Other than that, the image under both the first resolution version and the second resolution version may have identical or similar image size, color saturation brightness and other parameters. As a result, when the device 500 overlaps the first resolution version of the ith image onto the second resolution version of the ith image, users may only perceive that the definition of the ith image is slightly reduced, while other part of the image content is not changed at all.

Operation 204 may further include the following sub-operations.

First, the device 500 may overlap the first resolution version of the ith image with a transparency value of 0 on the second resolution version of the currently displayed ith image.

Second, the device 500 may gradually adjust the transparency value of the first resolution version of the ith image from 0 to 1.

Because the second resolution version of the ith image currently displayed is overlapped by gradually adjusting the transparency of the first resolution version of the ith image, the device 500 may avoid users' visual impact resulted from the reduction of definition (e.g., reduction of sharpness) of the ith image, thereby allowing the users to relatively lenitively adapt themselves to the differences caused by the image switching process.

As shown in FIG. 2B, the device 500 may overlap the 2K resolution version 23 of the first image onto the 4K resolution version 22 of the first image.

In Operation 205, the device 500 may replace the second resolution version of the ith image with the second resolution version of the (i+1)th image.

After the second resolution version of the ith image is covered over by the first resolution version thereof, the device 500 may replace the second resolution version of the ith image with the second resolution version of the (i+1)th image. In the process of above replacement, because the first version of the ith image covers the second version of the ith image, users may see the opaque first resolution version of the ith image displayed in the front, unable to perceive the replacement progress below the first version of the ith image.

As shown in FIG. 2B, the 4K resolution version 22 of the first image is replaced with the 4K resolution version 24 of the second image by the electronic equipment.

In Operation 206, the device 500 may hide the first resolution version of the ith image according to predetermined animation effects and display the second resolution version of the (i+1)th image.

The predetermined animation effects may be fade-out, jalousie, checkerboard, fly-out, splitting and the like. When the predetermined animation effect is fade-out, the operation may include following sub-operations.

First, the device 500 may adjust the transparency of the first resolution version of the ith image from 1 to 0.

Second, the device 500 may display the second resolution version of the (i+1)th image.

When the transparency of the first resolution version of the ith image is gradually adjusted from 1 to 0, the first resolution version of the ith image gradually changes from opacity to complete transparence, i.e., the first resolution version of the ith image fades out in a fade-out animation effect. In the meantime, the second resolution version of the (i+1)th image overlapped under the first resolution version of the ith image fades in. The second resolution version of the (i+1)th image is fully displayed when the transparency of the first resolution version of the ith image turns into 0.

In addition, in the automatic mode display mode, the device 500 may display the second resolution version of the (i+1)th image for a preset display duration and then display the next image. In the manual mode, the device 500 may keep displaying the second resolution version of the (i+1)th image until receiving the user's instruction (e.g., a trigger signal) to display the next image.

As shown in FIG. 2B, the 4K resolution version 24 of the second image is fully displayed when the transparency of the 2K resolution version 23 of the first image is gradually adjusted from 1 to 0. In addition, the process where the 4K resolution version 24 of the second image is switched to the 4K resolution version 26 of the third image is the same as that where the 4K resolution version 22 of the first image is switched to the 4K resolution version 24 of the second image.

In Operation 207, when the (i+1)th image is the last one, the device 500 may determine that the (i+1)th image is the last one to be displayed, and then overlap the first resolution version of the (i+1)th image with a transparency of 0 on the second resolution version of the (i+1)th image currently displayed.

In Operation 208, the device 500 may gradually adjust the transparency of the first resolution version of the (i+1)th image from 0 to 1.

The foregoing Operations 207-208 are similar to Operation 204, after the second resolution version of the last image in a set of images is displayed, the second resolution version of the last image currently displayed is overlapped by gradually adjusting the transparency of the first resolution version of the last image so that the second resolution version of the last image fades out of sight of users.

As shown in FIG. 2B, the 2K resolution version 27 of the third image is overlapped by the electronic equipment onto the 4K resolution version 26 of the third image, and the transparency of the 2K resolution version 27 of the third image is gradually adjusted from 0 to 1 so that the 4K resolution version 26 of the third image fades out.

In conclusion, the image switching method provided by the embodiment solves a problem that smooth switching is unavailable among a plurality of 4K images by means of predetermined animation effects, thus leading to poor display effect. During switching and displaying 4K images, the device 500 may execute the image switching method to overlap a first resolution version of an ith image on a second resolution version of the ith image currently displayed on the device 500, replace the second resolution version of the ith image with a second resolution version of an (i+1)th image, and hide the first resolution version of the ith image according to the predetermined animation effects, and display the second resolution version of the (i+1)th image. In the process of switching the second resolution versions of two adjacent images, the device 500 may use the first resolution version of the previous image to serve as a linkage, smooth switching of the second resolution versions of both the adjacent images by the animation effect generated by the first resolution version of the previous image. Thus the method not only improves the effect during switching and displaying both images but also enhances user experience.

In addition, in the image switching method according to the embodiment, the transparency of the first resolution version of the previous image is adjusted and the first resolution version of the previous image is taken as cinematics so that the second resolution version of the next image fades in, which may allow users to relatively lenitively adapt themselves to definition differences caused by the image switching process. Meanwhile, demands for the electronic equipment's computer processing capability may be adequately reduced, thus guaranteeing the fluency in switching images.

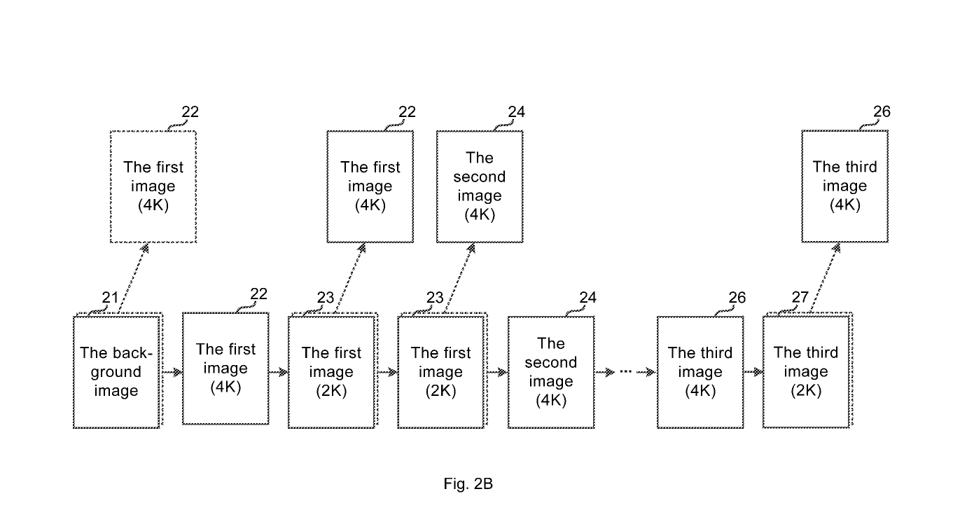

FIG. 3 is a block diagram of an image switching device according to an example embodiment. The image switching device may be the electronic equipment, such as device 500, in part or in whole by software or hardware or combination of both. The image switching device may include: an image overlapping module 310, an image replacement module 320 and an image display module 330.

The image overlapping module 310 may be configured to overlap the first resolution version of an ith image on the second resolution version of the ith image currently displayed, and the resolution of the first resolution version is below that of the second resolution version, i≧1.

The image replacement module 320 may be configured to replace the second resolution version of the ith image with the second resolution version of the (i+1)th image.

The image display module 330 may be configured to hide the first resolution version of the ith image according to predetermined animation effects and to display the second resolution version of the (i+1)th image.

In conclusion, the image switching method provided by the embodiment solves a problem that smooth switching is unavailable among a plurality of 4K images by means of predetermined animation effects, thus leading to poor display effect. During switching and displaying 4K images, the device 500 may execute the image switching method to overlap a first resolution version of an ith image on a second resolution version of the ith image currently displayed on the device 500, replace the second resolution version of the ith image with a second resolution version of an (i+1)th image, and hide the first resolution version of the ith image according to the predetermined animation effects, and display the second resolution version of the (i+1)th image. In the process of switching the second resolution versions of two adjacent images, the device 500 may use the first resolution version of the previous image to serve as a linkage, smooth switching of the second resolution versions of both the adjacent images by the animation effect generated by the first resolution version of the previous image. Thus the method not only improves the effect during switching and displaying both images but also enhances user experience.

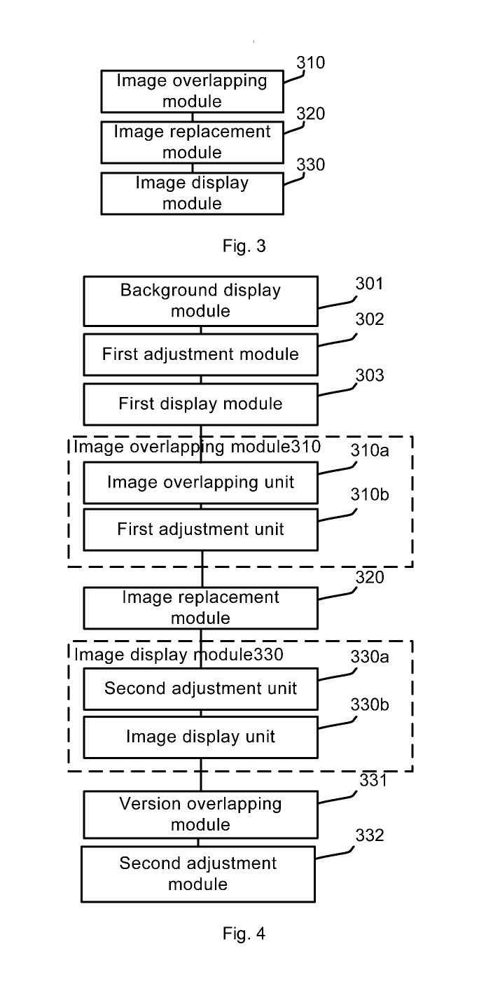

FIG. 4 is a block diagram of an image switching device according to another example embodiment. The image switching device may be the electronic equipment, such as device 500, in part or in whole by software or hardware or combination of both. The image switching device may include: an image overlapping module 310, an image replacement module 320 and an image display module 330.

The image overlapping module 310 may be configured to overlap the first resolution version of an ith image on the second resolution version of the ith image currently displayed, and the resolution of the first resolution version is below that of the second resolution version, i≧1.

The image overlapping module 310 may further include: an image overlapping unit 310a and a first adjustment unit 310b.

The image overlapping unit 310a may be configured to overlap the first resolution version of the ith image with a transparency of 0 on the second resolution version of the ith image currently displayed.

The first adjustment unit 310b may be configured to gradually adjust the transparency of the first resolution version of the ith image from 0 to 1.

The image replacement module 320 may be configured to replace the second resolution version of the ith image with the second resolution version of the (i+1)th image.

The image display module 330 may be configured to hide the first resolution version of the ith image according to predetermined animation effects and to display the second resolution version of the (i+1)th image.

The image display module 330 may further include: a second adjustment unit 330a and an image display unit 330b.

The second adjustment unit 330a may be configured to gradually adjust the transparency of the first resolution version of the ith image from 1 to 0.

The image display unit 330b may be configured to display the second resolution version of the (i+1)th image.

The device may also include: a background display module 301, a first adjustment module 302 and a first display module 303.

The background display module 301 may be configured to display a background image with a transparency of 1, the background image may be overlapped on the second resolution version of the first image, and the background image may be the image with the first resolution version.

The first adjustment module 302 may be configured to gradually adjust the transparency of the background image from 1 to 0.

The first display module 303 may be configured to display the second resolution version of the first image.

The device may also include: a version overlapping module 331 and a second adjustment module 332.

The version overlapping module 331 may be configured to overlap the first resolution version of the (i+1)th image with a transparency of 0 on the second resolution version of the (i+1)th image currently displayed when the (i+1)th image is the last image in a group of images to be displayed.

The second adjustment module 332 may be configured to gradually adjust the transparency of the first resolution version of the (i+1)th image from 0 to 1.

In conclusion, the image switching method provided by the embodiment solves a problem that smooth switching is unavailable among a plurality of 4K images by means of predetermined animation effects, thus leading to poor display effect. During switching and displaying 4K images, the device 500 may execute the image switching method to overlap a first resolution version of an ith image on a second resolution version of the ith image currently displayed on the device 500, replace the second resolution version of the ith image with a second resolution version of an (i+1)th image, and hide the first resolution version of the ith image according to the predetermined animation effects, and display the second resolution version of the (i+1)th image. In the process of switching the second resolution versions of two adjacent images, the device 500 may use the first resolution version of the previous image to serve as a linkage, smooth switching of the second resolution versions of both the adjacent images by the animation effect generated by the first resolution version of the previous image. Thus the method not only improves the effect during switching and displaying both images but also enhances user experience.

In addition, in the image switching device according to the embodiment, the transparency of the first resolution version of the previous image is adjusted and the first resolution version of the previous image is taken as cinematics so that the second resolution version of the next image fades in, which may allow users to relatively lenitively adapt themselves to definition differences caused by the image switching process. Meanwhile, demands for the electronic equipment's computer processing capability may be adequately reduced, thus guaranteeing the fluency in switching images.

With regard to the device in the above embodiment, detailed description of specific modes for executing operation of modules has been made in the embodiment of the methods, no detailed illustration will be made herein.

While example embodiments of the present disclosure relate to methods and devices for 4K image switching, other embodiments of the invention will be apparent to those skilled in the art from consideration of the specification and practice of the invention disclosed here. For example, the methods and devices may also be applied to images with other resolutions, or may be applied to image switching process of video streaming. This application is intended to cover any variations, uses, or adaptations of the invention following the general principles thereof and including such departures from the present disclosure as come within known or customary practice in the art. It is intended that the specification and examples be considered as example only, with a true scope and spirit of the invention being indicated by the following claims.

Thus, example embodiments illustrated in FIGS. 1-5 serve only as examples to illustrate several ways of implementation of the present disclosure. It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. An electronic device, comprising:
a processor-readable storage medium storing a set of instructions for displaying a group of images; and
a processor in communication with the storage medium, wherein when executing the set of instructions, the processor is directed to:
overlap a first image with a first resolution over the first image with a second resolution that is currently displayed by the electronic device, wherein the first resolution is different from the second resolution;
replace the first image with the second resolution with a second image with the second resolution;
hide the first image with the first resolution according to a predetermined animation effect; and
display the second image with the second resolution.

2. The electronic device of claim 1, wherein the first image with the first resolution is transparent when being overlapped over the first image with the second resolution; and
to overlap the first image with the first resolution over the first image with the second resolution, the processor is further directed to:
gradually adjust a transparency of the first image with the first resolution version from transparence to opacity.

3. The electronic device of claim 2, wherein to hide the first image with the first resolution, the processor is further directed to:
gradually adjust the transparency of the first image with the first resolution from opaque to transparence.

4. The electronic device of claim 1, wherein the processor is further directed to:
display an opaque background image by overlapping the background image over the first image with the second resolution; and
gradually adjust a transparency of the background image from opaque to transparence; and
display the first image with the second resolution.

5. The electronic device of claim 1, wherein the processor is further directed to:
determine that when the second image is a last image of the group of images;
overlap a transparent second image with the first resolution version over the second image with the second resolution; and
gradually adjust a transparency of the second image with first resolution from transparence to opaque.

6. The electronic device of claim 1, wherein the first resolution is lower than the second resolution.

7. The electronic device of claim 1, wherein the predetermined animation effect is one of fade-out, jalousie, checkerboard, fly-out, and splitting,
the first resolution is 4K resolution, and
the second resolution is 2K resolution.

8. A method for displaying a group of images, comprising:
overlapping, by an electronic device, a first image with a first resolution over the first image with a second resolution that is currently displayed by an electronic device, wherein the first resolution is different from the second resolution;
replacing, by the electronic device, the first image with the second resolution with a second image with the second resolution;
hiding, by the electronic device, the first image with the first resolution according to a predetermined animation effect; and
displaying, by the electronic device, the second image with the second resolution.

9. The method of claim 8, wherein the first image with the first resolution is transparent when being overlapped over the first image with the second resolution; and
the overlapping of the first image with the first resolution over the first image with the second resolution comprises gradually adjusting a transparency of the first image with the first resolution version from transparence to opacity.

10. The method of claim 9, wherein the hiding of the first image with the first resolution comprises gradually adjusting the transparency of the first image with the first resolution from opaque to transparence.

11. The method of claim 8, further comprising:
displaying, by an electronic device, an opaque background image by overlapping the background image over the first image with the second resolution; and
gradually adjusting, by an electronic device, a transparency of the background image from opaque to transparence; and
displaying, by an electronic device, the first image with the second resolution.

12. The method of claim 8, further comprising:
determining, by an electronic device, that when the second image is a last image in the group of images;
overlapping, by an electronic device, a transparent second image with the first resolution version over the second image with the second resolution; and
gradually adjusting, by an electronic device, a transparency of the second image with first resolution from transparence to opaque.

13. The method of claim 8, wherein the first resolution is lower than the second resolution.

14. The method of claim 13, wherein the predetermined animation effect is one of fade-out, jalousie, checkerboard, fly-out, and splitting,
the first resolution is 4K resolution, and
the second resolution is 2K resolution.

15. A non-transitory processor-readable storage medium, comprising a set of instructions for displaying a group of images, wherein when being executed by a processor, the set of instructions directs the processor to conduct operations of:
overlapping a first image with a first resolution over the first image with a second resolution that is currently displayed by an electronic device, wherein the first resolution is different from the second resolution;
replacing the first image with the second resolution with a second image with the second resolution;
hiding the first image with the first resolution according to a predetermined animation effect; and
displaying the second image with the second resolution.

16. The storage medium of claim 15, wherein the first image with the first resolution is transparent when being overlapped over the first image with the second resolution; and
the overlapping of the first image with the first resolution over the first image with the second resolution comprises gradually adjusting a transparency of the first image with the first resolution version from transparence to opacity.

17. The storage medium of claim 16, wherein the hiding of the first image with the first resolution comprises gradually adjusting the transparency of the first image with the first resolution from opaque to transparence.

18. The storage medium of claim 15, wherein the set of instructions further directs the processor to conduct operations as:
displaying an opaque background image by overlapping the background image over the first image with the second resolution; and
gradually adjusting a transparency of the background image from opaque to transparence; and
displaying the first image with the second resolution.

19. The storage medium of claim 15, wherein the set of instructions further directs the processor to conduct operations of:
determining that when the second image is a last image in the group of images;
overlapping a transparent second image with the first resolution version over the second image with the second resolution; and
gradually adjusting a transparency of the second image with first resolution from transparence to opaque.

20. The storage medium of claim 15, wherein the predetermined animation effect is one of fade-out, jalousie, checkerboard, fly-out, and splitting, the first resolution is 4K resolution, and the second resolution is 2K resolution.
